(19) United States
(12) Patent Application Publication
(10) Pub. No.: US 2011/0314640 A1
(43) Pub. Date: Dec. 29, 2011

(54) Attachable Gel Strap Wrap and Method

(76) Inventor: Patrick M. Reynolds, Everett, WA (US)

(21) Appl. No.: 13/167,090

(22) Filed: Jun. 23, 2011

Related U.S. Application Data
(60) Provisional application No. 61/398,446, filed on Jun. 26, 2010.

(51) Int. Cl. B25G 1/10

(52) U.S. Cl. 16/430

(57) ABSTRACT

A gel strap wrap selectively used with a strap attached to a heavy object that evenly and continuously distributes the forces exerted by the strap over a larger area on the user's body thereby reducing discomfort and fatigue. The gel strap wrap includes a square or rectangular-shaped wrap body that includes a central panel section and two opposite side panel sections. Located inside the central panel section is a pouch that contains a gel pack filled with gel material. The gel pack includes three, longitudinally aligned closed chambers. The weld lines seal the chambers and act as hinges that allow the gel pack to bend over a round or curved body surface. Formed on the inside and outside surfaces of the side panels are loop and hook connector pads. During use, the wrap body which is then longitudinally aligned over the desired surface of the shoulder or hand where the strap or handle will be placed. The strap or handle is then extend over the center panel section and the two side panel sections are then folded around the strap so that the hook and loop connector pads are interconnected to securely hold the wrap body in place under the strap.

This U.S. utility patent application is based on claims the filing date of U.S. Provisional Patent Application (Application No. 61/398,446) filed on Jun. 26, 2010.

### COPYRIGHT NOTICE

Notice is hereby given that the following patent document contains original material which is subject to copyright protection. The copyright owner has no objection to the facsimile or digital download reproduction of all or part of the patent document, but otherwise reserves all copyrights whatsoever.

### BACKGROUND OF THE INVENTION

1. Field of the Invention

The present invention relates generally to handle or strap accessories intended to be selectively used with an existing grip handle or shoulder strap to more evenly distribute the forces exerted by the handle or shoulder strap to reduce user fatigue or discomfort.

2. Description of the Related Art

People often carry ‘carry-on’ luggage and small handbags when traveling at airports. Security check points at airports require that the carry-on luggage and small handbags be scanned for contraband material. Any containers containing more than 3 ounces of a liquid or paste must be removed from the luggage and handbags and discarded.

The distance from the security check point to the loading terminal at an airport can be several thousand feet. Manually transporting carry-on luggage and small hand bags this distance can be difficult for some individuals. Accessories that can make this task easier would be desirable so long as they are permitted at security check points and can be selectively attached or removed from the luggage or handbag.

### SUMMARY OF THE INVENTION

It is an object of the present invention to provide an accessory that can be selectively attached to the handle or strap of piece of luggage or handbag that evenly distributes the weight of the luggage or bag over the user's handle or shoulder.

It is another object of the present invention to provide such an accessory that is acceptable at airport security check points thereby enabling them to be used by passengers to carry luggage and handbags to and from the loading terminals.

It is another object of the present invention to provide a protective strap wrap filled with a relative small volume of gel material that conforms in shape thereby enabling the strap wrap to conform and retain its shape when used with different shapes and styles of straps and handles.

The above objects are met by the gel strap wrap disclosed herein that includes a square or rectangular-shaped wrap body that is divided into a central panel and two opposite side panels. Located inside the central panel is a sealed, multiple chamber, gel pack. Each chamber is sealed and partially filled with a relative small volume of gel material. Sealing weld lines are formed between adjacent chambers that act as hinges that allow the gel pack to bend over a round or curved surfaces.

The wrap body is made of fabric that can be easily rolled or folded into a compact configuration. During use, the wrap body may be conveniently stored in an outside pocket on the luggage or bag. When needed, it is removed from the pocket and longitudinally aligned over the user's hand or shoulder where a handle or strap is normally positioned. The handle or strap is then extended over the top surface of the center panel and the two side panels are then folded over the handle or strap and connected together to securely hold the wrap body in place. When the wrap body is no longer needed or desired, the wrap body can be removed from the handle or strap and returned to the outside pocket.

In the first embodiment, the total volume of gel material in the gel pack is limited to an amount at or below the volume permitted or acceptable at airport security check points. Also, attachment of the adjoining surfaces on the opposite side panels is accomplished by hook and loop connectors that allow the user to adjust the general configuration of the wrap body to the desired strap or handle.

### DESCRIPTION OF THE DRAWINGS

FIG. 1 is a top plan view of the gel strap wrap with a strap longitudinally aligned over the wrap's top surface.

FIG. 2 is a bottom view of the gel strap wrap shown in FIG. 1 showing the gel pack located inside the pouch formed in the center panel.

FIG. 3 is a top plan view of the gel strap wrap with a handle longitudinally aligned over the wrap's top surface.

FIG. 4 is a bottom view of the gel strap wrap shown in FIG. 1 showing the gel pack located inside the pouch formed in the center panel.

FIG. 5 is a sectional side elevational view of the gel strap wrap and the strap as shown along line 5-5 in FIG. 1.

FIG. 6 is a perspective view of the gel pack showing the three gel chambers able to bend around the sealed hinges.

FIG. 7 is a top plan view of the gel strap wrap shown in FIG. 1 with optional rubber covers attached to the top surfaces of the side and center panels to prevent slippage.

### DESCRIPTION OF THE PREFERRED EMBODIMENT(S)

Referring to the accompanying FIGS., there is shown gel strap wrap 10 designed to be selectively attached to the strap 90 or a handle 95 attached to an object to be manually carried. The gel strap wrap 10 is designed to conform to the forces exerted by the strap 90 or handle 95 against the user's shoulder or and thereby evenly distribute a load.

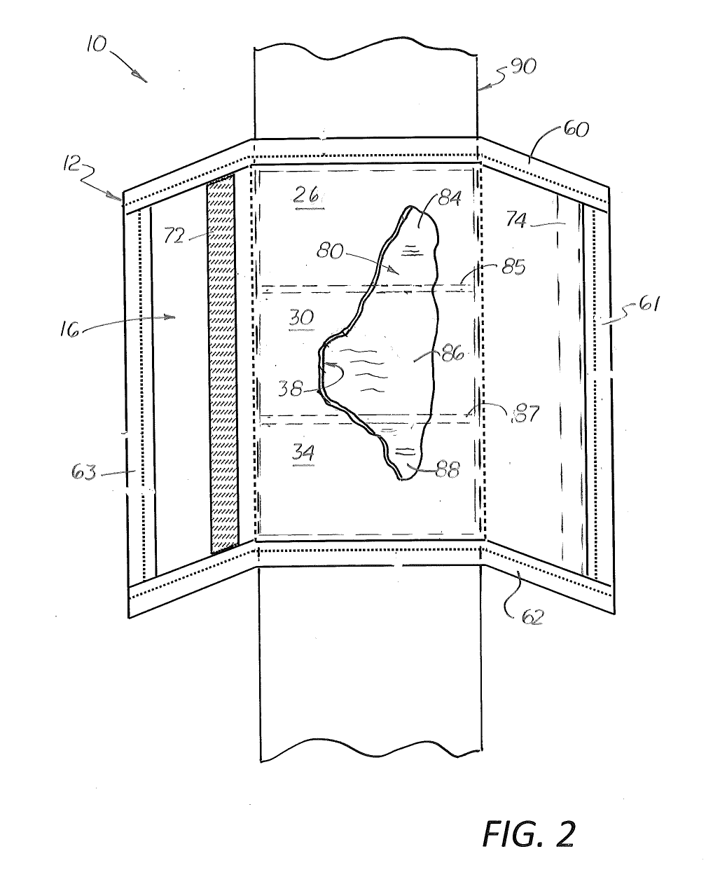

The gel strap wrap 10 comprises a square or rectangular wrap body 12 made of an upper layer 14 and a lower layer 16 that are aligned and registered and sewn together at their perimeter edges 18, 19, 20, and 21. The wrap body 12 is divided into three parallel, panel sections 26, 30, 34, by two longitudinally aligned stitching 40, 42. The panel sections 26, 30 and 34 are substantially the same height and width. As shown in FIG. 2, formed in the center panel section 30 is an elongated gel pack pouch 38 in which a gel pack 80 is placed.

In the preferred embodiment, the upper layer 14 and lower layer 16 are made of durable cotton fabric, synthetic or natural fiber, or nylon sheeting.

The gel pack 80 includes three sealed, separate chambers 84, 86, and 88 that contain the gel material 100. The perimeter edges of the chambers 84, 86, and 88 are sealed thereby preventing gel material 100 from flowing between the three chambers 84, 86, 88 when pressure is applied. By sealing each chamber 84, 86, 88, when downward pressure is applied, pressure is evenly dispersed across the entire surface of the gel pack 80. In the embodiment shown in FIGS. 2 and 6, two transversely aligned, heat sealing hinges 85, 87 are formed on the gel pack body 82 that form substantially three equal size chambers 84, 86, 88. These heat sealed hinges 85, 87 provide a hinge functionality to allow the gel pack body 82 to bend as shown in FIG. 6 and thereby conform to a rounded surface. Each sealed hinge 85, 87 is approximately 2 mm wide.

In one embodiment, the gel pack body 82 may be made of polyurethane plastic approximately 6 mils in thickness. The length of the gel pack body 82 is approximately ½ inch less than then length of the pouch 38 formed in the center panel section 30. In the embodiment shown in the FIGS., the gel pack body 82 is approximately 7½ inches in length, and 3 inches wide. It should be understood that the size and shape of the gel pack body 82 can vary and that the amount of gel material 100 used in each chamber 84, 86, 88 can be varied. In the embodiment shown herein, the wrap 10 is specifically designed for airline travelers where in each chamber 84, 86, and 88 contains approximately 1 fluid oz thereby making each chamber 84, 86, 88 approximately ¼ inch think.

Different gel material 100 can be used. In this instance, the inventor has found blue Hot and Cold gel material 100 to be desirable because it is non-toxic and can easily handle extreme heat and cold temperatures without breaking down.

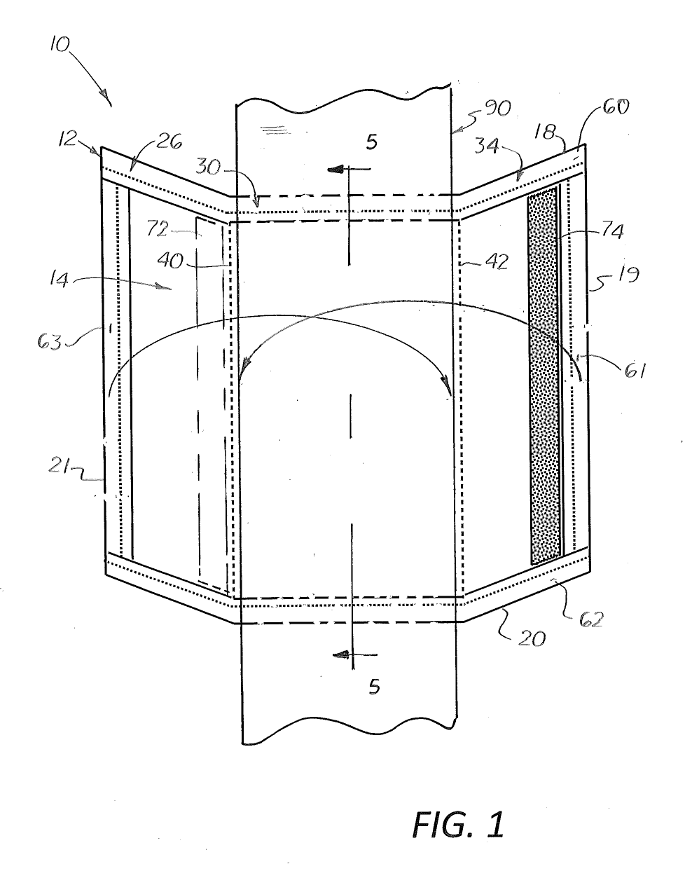

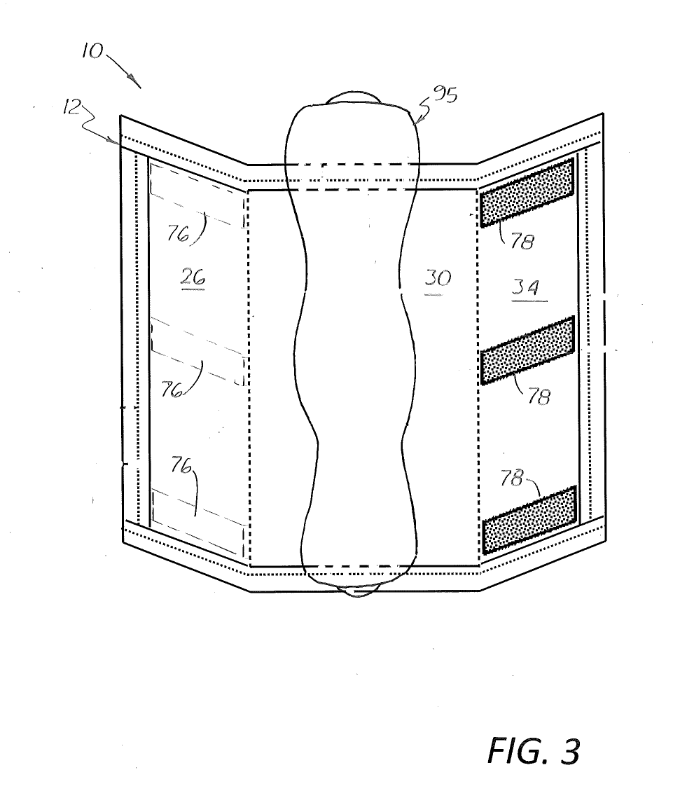

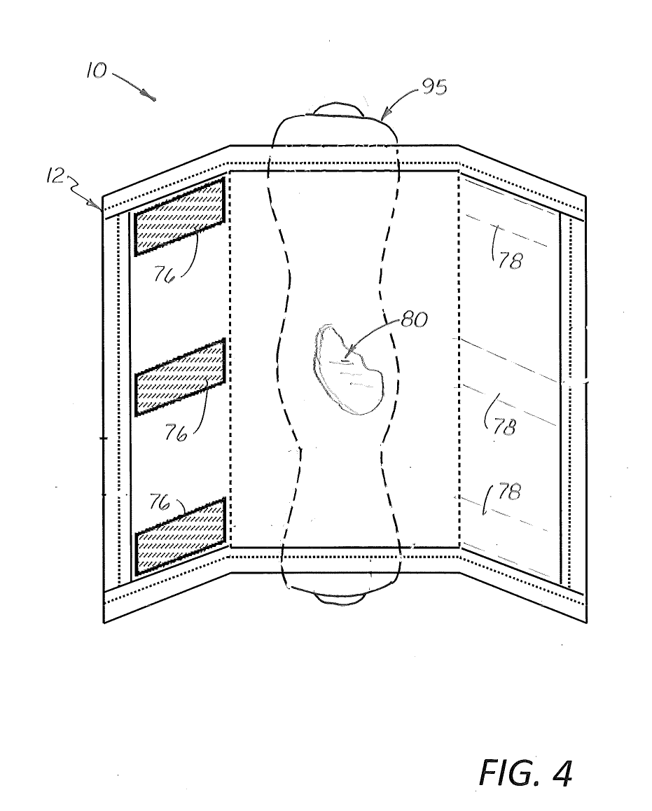

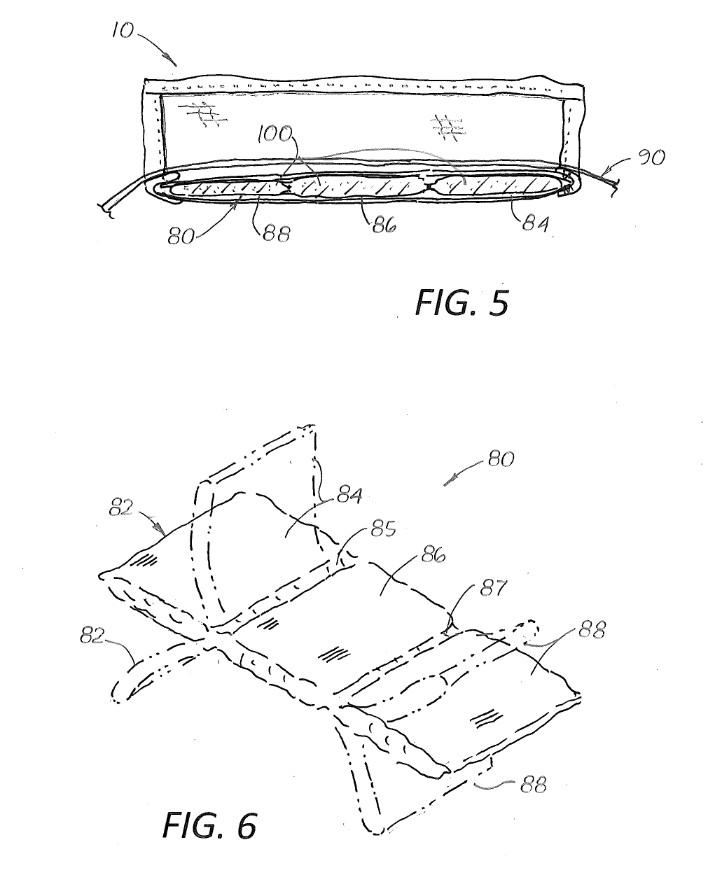

In the embodiments shown in FIGS. 1, 2, and 7, two elongated hook and loop connector strips 72, 74 are longitudinally aligned and mounted on the opposite adjoining surfaces of the two side panels 26, 34, respectively. Alternatively, as shown in FIGS. 3 and 4, a plurality of transversely aligned hook and loop connector strips 76. 78 are mounted on the opposite adjoining surfaces of the two side panel sections 26, 34 respectively.

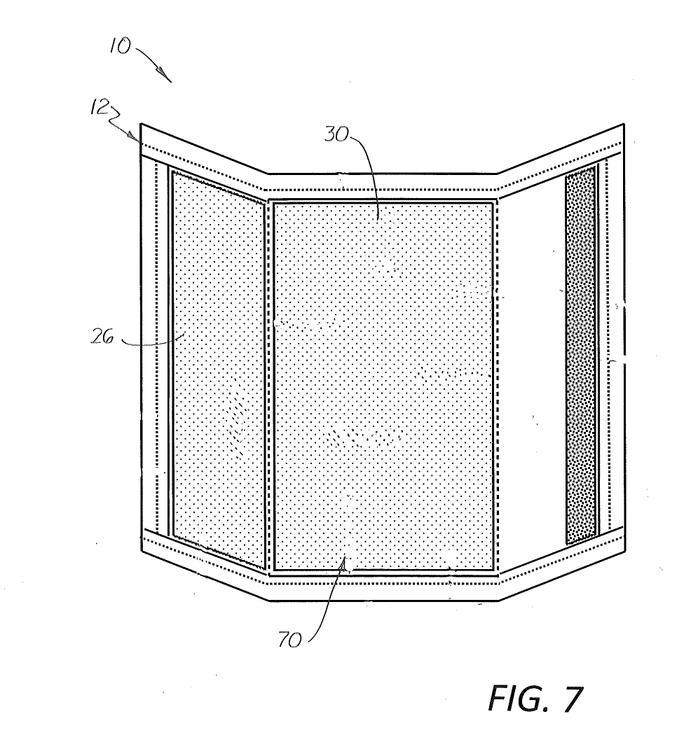

As shown in FIG. 7, an optional friction coating 70 made of rubber, latex or other non-skid material may be applied to the upper or lower surfaces of one or two side panel sections (only side panel section 26 and central panel section 30 shown covered with non-skid material).

To manufacture the gel pack wrap 10, the upper fabric panel and lower panels are cut to size, (9¾ (w)×8 inches (1)). The two layers are then aligned and registered and the perimeter edges are then stitched together. Four pieces of finishing tape or bias tape 60-63 are now selected and sewn along the top perimeter edge 18, right perimeter edge 19, bottom perimeter edge 20 and left side perimeter edge 21, respectively. Prior to sewing the top perimeter edge 18, the gel pack 80 is selected and inserted into pouch 38.

During use, the two side panel sections 26, 35 are wrapped over the center panel section 30 and around the strap 90 or the handle 95 that is longitudinally aligned thereover. Hook and loop connectors 72, 74 or 76, 78 are then engaged to hold them in a wrapped position around the strap 90 or handle 95.

Using the above gel wrap strap, a method for distributing the force exerted by a strap 90 or handle 95 attached to an object and used to transport the object, comprising the following steps:
a. selecting a gel pack wrap 10 that includes a flexible wrap body 12 divided into a central panel section 30 with a pouch 38 formed therein, and two side panel sections 26, 34 with a gel pack 80 longitudinally aligned inside said pouch 38, said gel pack 80 includes at least two transversely aligned seams 85, 87 that divide said gel pack into three chambers 82,84, 86, each said chamber 82, 84, 86 being filled with gel material 100, said seams 85, 87 being sufficient wide so that said gel pack 80 may bend and conform in shape and thereby dissipate forces exerted by a strap aligned longitudinally adjacent to said wrap body 12, said gel pack 10 also including means for holding the opposite side panel sections 26, 34 in a wrapped configuration around said central panel section 30;
b. selecting a strap 90 or handle 95 attached to an object to be carried and identifying the contact area of said strap 90 or handle 95 that will be placed adjacent to the person's hand or shoulder, said contact area having a length approximately equal to the length of said central panel section 30 and having a width equal to or less than said central panel section 30;
c. positioning a strap 90 or handle 95 longitudinally over said gel pack 80 so that the contact area is longitudinally aligned and centrally positioned over said central panel section 30;
d. extending said side panel sections 26, 34 s around said strap 90 or handle 95 and engaging said means for holding the opposite side panel sections 26, 34 thereover; and,
e. positioning said gel pack wrap 10 over the shoulder or holding said gel pack wrap 10 in a hand to transport the object.

I claim:

1. A gel wrap strap for carrying a strap or handle, comprising:
a. a wrap body that includes an inner layer, an outer layer, said wrap body being divided into a center panel section and least two side panel sections, said center panel section includes a concealed pouch;
b. a gel pack located inside said pouch, said gel pack includes at least two transversely aligned seams that divide the gel pack into a center chamber and at least two end chambers, each said chamber being filled with approximately 1 fluid ounce of gel material; and,
c. at least one pair of hook and loop connectors located on the adjacent surfaces of said side panel sections of said wrap body, when said inner layer and said central panel section is longitudinally aligned under a strap or handle said side panel sections are folded over said central panel section and over the strap or handle and said pair of hook and loop connectors on opposite adjoining surfaces on said side panel sections are engaged to hold said wrap body in place around the strap or handle.

2. A method for distributing the force exerted by a strap attached to an object and used to transport the object, the method comprising the following steps:
a. selecting a gel pack wrap that includes a flexible wrap body divided into a central pocket and two side panels with a gel pack longitudinally aligned inside said central pocket, said gel pack includes at least two transversely aligned seams that divide said gel pack into a center chamber and at least two end chambers, each said chamber being filled with paste-like gel material, said seams being sufficiently wide so that said gel pack may bend and conform in shape and thereby dissipate forces exerted by a strap aligned longitudinally adjacent to said wrap body, said gel pack also including means for holding the opposite side panels in a wrap configuration around said central pocket;
b. selecting a strap or handle attached to an object to be carried and identifying the contact area of said strap that will be placed adjacent to the person's hand or shoulder, said contact area having a length approximately equal to the length of said central panel section and having a width equal to or less than said central panel section;
c. positioning a strap longitudinally over said gel pack so that the contact area is longitudinally aligned and centrally positioned over said central panel section;
d. extending said side panels around said strap and engaging said means for holding the opposite side panels; and,
e. positioning said gel pack wrap over the shoulder or holding said gel pack in a hand to transport the object.
